(19) United States
(12) Patent Application Publication
(10) Pub. No.: US 2014/0379576 A1
(43) Pub. Date: Dec. 25, 2014

(54) TRANSACTION APPROVAL FOR SHARED PAYMENT ACCOUNT

(71) Applicants: Joseph A. Marx, Sinking Spring, PA (US); Scott Kessler, Furlong, PA (US)

(72) Inventors: Joseph A. Marx, Sinking Spring, PA (US); Scott Kessler, Furlong, PA (US)

(21) Appl. No.: 13/926,896

(22) Filed: Jun. 25, 2013

(51) Int. Cl. G06Q 20/38

(52) U.S. Cl. CPC G06Q 20/388
USPC 705/44

(57) ABSTRACT

A primary user of a payment account may designate one or more secondary users who may access and utilize the primary user's payment account. When a secondary user is making a transaction using the payment account, the primary user may be notified in real time. The transaction may be delayed for a specified period of time until approval from the primary user is received. The transaction may be processed if approval from the primary user is received within the specified period of time. On the other hand, the transaction may be canceled or denied if the primary user disapproves the transaction or if the specified period of time has expired without receiving approval from the primary user.

### BACKGROUND

1. Field of the Invention

The present invention generally relates to systems and methods for implementing payment transaction approvals in a shared payment account.

2. Related Art

Payment service providers, such as PayPal, Inc. of San Jose, Calif., provide convenient transfer of funds for both the sending and receiving parties. In particular, payment service providers may be used to conduct internet commerce. For example, a user may set up a payment account and may use the payment account to send money to an online merchant.

A payment account usually is assigned to and used by one user to conduct fund transfer or online purchase. Even though a user may allow another person to access and use the user's online payment account, it may be difficult for the user to monitor how the others use the online payment account to prevent account misuse. For example, a parent may grant his or her child access to the parent's payment account, such that the child may purchase any necessities in the parent's absence. Nevertheless, it is difficult for the parent to monitor how the payment account is being used by the child in real time in order to prevent the child from making improper purchases or from overspending.

Thus, there is a need for a system or method that allows a primary user of a payment account to monitor or control how the payment account is used by a secondary user in real time.

### BRIEF DESCRIPTION OF THE FIGURES

FIG. 1 is a flowchart showing a process for approving a payment transaction in according to one embodiment.

FIG. 2 is a sequence diagram showing a process for approving a payment transaction according one embodiment.

FIG. 3 is block diagram of a networked system suitable for implementing a process for approving a payment transaction according to an embodiment.

FIG. 4 is a block diagram of a computer system suitable for implementing one or more components in FIG. 3 according to one embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

According to one embodiment, a primary user of a payment account may designate one or more secondary users who may utilize the primary user's payment account. When a secondary user is making a transaction, e.g., an online purchase or online fund transfer, using the payment account, the primary user may be notified in real time. The transaction may be delayed for a specified period of time until approval from the primary user is received. The transaction may be processed if approval from the primary user is received within the specified period of time. On the other hand, the transaction may be canceled or denied if the primary user disapproves the transaction or if the specified period of time has expired without receiving approval from the primary user.

In one embodiment, a system or method may allow the primary user to designate one or more secondary users. The primary user may designate restrictions for each secondary user, such as the type of transaction that requires approval from the primary user, e.g., purchases greater than $10.00, or a daily spending limit. In addition, the receivers of the transaction, e.g., online merchants, may adjust the length of the specified delay time based on the type of transaction. For example, for food service, a shorter period of time, e.g., 15 minutes, may be used. On the other hand, for purchase of electronics, a longer period of time, e.g., 24 or 48 hours, may be used, Thus, based on the type of transaction or other transaction information (such as amount of purchase), appropriate delay may be provided pending the primary user's approval.

In another embodiment, the primary user may specify that certain purchases that will default to approval within a specified time limit even if the primary user does not actively communicate an approval. For example, the primary user may specify that a type of purchases that are related to education may have a $400 maximum spending amount. Further, the primary user may also specify that this type of purchases may automatically be approved when the period of delay time expires without the primary user's approval. Thus, unless the primary user objects to or denies the transaction within the period of delay time, the transaction may automatically be approved without the primary user's response. For example, if the secondary user is a child of the primary user and a college student, the primary user may allow purchases for books at a student store for up to $400 even when the primary user has not communicated a real-time approval within four minutes of the purchase request.

In one embodiment, the primary user may be notified when the secondary user is within a payment location, such as a merchant store, restaurant, etc. For example, the primary user may specify in the restriction profile of the secondary user to require that a notification be sent to the primary user when the secondary user is within a type of location or store. When a mobile device of the secondary user is detected at a store location, the primary user may receive a text or voice message on a primary user device. This alerts the primary user that the secondary user may be making a purchase soon, such that the primary user may prepare for an upcoming payment request. For example, the primary user may keep the mobile device turned on and not move to a location with no communication coverage, etc.

In another embodiment, the primary user may choose to pre-approve any possible purchase in the store. For example, when the secondary user enters an Italian restaurant for lunch. The mobile device of the secondary user may detect the location of the secondary user and may forward the location to the service provider. The service provider may analyze the location of the secondary user and may determine that the secondary user has entered an Italian restaurant. The service provider may then send a notification to the primary user indicating that the secondary user has entered an Italian restaurant. The primary user may choose to pre-approve the secondary user's purchase in the Italian restaurant before the secondary user makes a purchase. Thus, when the secondary user makes a purchase later, the transaction may already have been pre-approved. In this instance, there may be no need to send another notification to the primary user requesting approval.

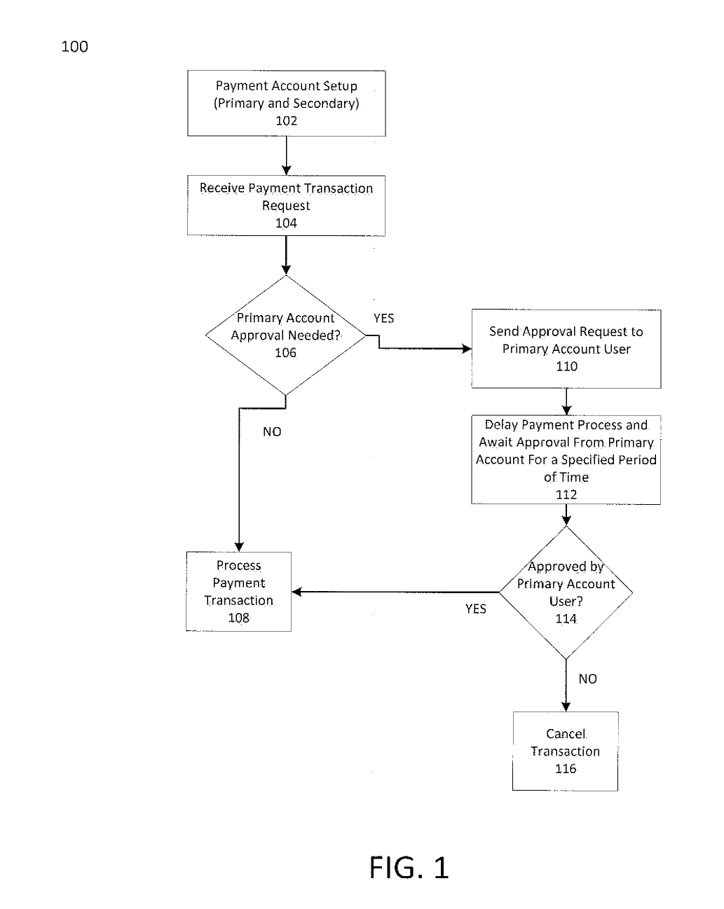

FIG. 1 is a flowchart showing a process 100 for approving a payment transaction according to one embodiment. At step 102, a primary user may set up a payment account with a service or payment provider, such as PayPal, Inc. of San Jose, Calif.. The primary user may designate one or more secondary users for the payment account. The secondary user may have access to the payment account and may use the payment account to make purchase or transfer funds. Each secondary user may have a unique login access, such as login ID and password. Each secondary user may use his or her unique login ID and password to access the payment account. The primary user may also set up a restriction profile for each secondary user. In the restriction profile, the primary user may set up the type of transactions that require the primary user's approval. For example, the primary user, e.g., a parent, may set up a restriction profile for a secondary user, e.g., a child, such that the-child may purchase food that is under $10.00, without the parent's approval. In the restriction profile, a primary user may also set up a maximum spending limit in a specific period of time, e.g., $100.00 a day. The primary user also may set up other restrictions, such as types of transaction or purchase that require approval. In another embodiment, the primary user may set up the restrictions profile to allow all transactions unless the primary user denies the transaction. Thus, all transactions may be processed unless the primary user denies the transaction within the delay time. Accordingly, the primary user may customize the types of transactions that require the primary user's approval.

Further, the primary user may set up an approval notification preference indicating how the approval request is communicated to the primary user. For example, the primary user may designate a telephone number to which the approval request may be forwarded by text message or a telephone call or an email address to which the approval request may be sent via email.

The secondary user may make an online purchase or a fund transfer using the payment account. The purchase may be at a physical point of sale, such as at a merchant location, online through a user's PC or other computing device, or through a mobile app on the user's mobile device. The purchase may be physical or digital goods. “Purchase” as used herein may also denote payment to another or an entity, such as a charitable donation.

The secondary user or the online purchase may send a transaction request to the service provider. Referring to step 104, the service provider may receive the transaction request and begin the process of verifying and approving the transaction. The service provider may verily the login and password entered by the secondary user. At step 106, the service provider may determine whether approval by the primary user is needed for the transaction request based on the restriction profile of the second user, which was previously set up by the primary user in step 102. The service provider may determine whether approval by the primary user is needed based on the type of purchase, including the amount of purchase, the type of merchant, or the purchased item. For example, if the restriction profile indicates that purchase at a bookstore does not need approval and if the secondary user is attempting to buy a book, the service provider may determine that approval by the primary user is not needed. On the other hand, if the restriction profile of the secondary user indicates that only transactions over $10.00 requires approval from the primary user and if the transaction request is for a $17.00 purchase, the service provider may determine that the approval from the primary user is required for this transaction. The service provider also may perform other verifications, such as fraud analysis.

If the service provider determines that no approval from the primary user is required, the service provider may proceed to process the payment transaction at step 108. The payment provider may credit an account of the merchant or payee and debit an account of the primary user.

On the other hand, if the service provider determines that approval from the primary is required based on the restriction profile of the secondary user, the service provider may forward an approval request to the primary user and delay the transaction for a specified period of time at step 110. As noted above, online merchants may set the specified delay time based on the type of purchases. For example, food vendors, such as a pizza shop, may set a shorter delay time of five minutes. Electronic retailers may set a longer delay time of 24 hours. The length of delay may also be set based on the amount of purchases, e.g., a larger amount may correspond to a longer delay. Thus, adequate delay time may be allotted for the primary user to respond and approve the purchase, based on the type of transactions.

At step 112, the service provider may forward the approval request to the primary user based on the approval notification preference set up by the primary user. For example, if the approval notification preference indicates text message with a phone number, the service provide may generate a text message including the approval request and send the text message to the primary user's phone number. The approval request may be forwarded via text message, email, instant message, telephone call, or the like. The approval request may include information such as the type of purchase being requested, the time, date, and location of the purchase, name of the merchant or payee, and the deadline for replying to the request. Thus, the primary user may be adequately informed of the type of purchase in order to determine a proper response regarding approval.

The primary user may approve or disapprove the request by replying to the approval request, such as by text or voice. For example, if the approval request is sent via text message, the primary user may reply to the text message with “YES”, “OK”, or “NO”. At step 114, the service provider may determine whether the primary user approves the transaction based on the primary user's response. If the service provider determines that the primary user approves the transaction at step 114, the service provider may process the payment transaction at step 108. For example, the service provider may credit an account of the merchant or payee and debit the payment account of the primary user.

On the other hand, if the service provider determines that the primary user disapproves or denies the transaction or if the service provider does not receive a response from the primary user before the delay time expires, the service provider may cancel the transaction at step 116. The service provider may inform the merchant or the secondary user, or both, that the transaction has been canceled and the reason for canceling the transaction. For example, if the service provider cancels the transaction because no response is received from the primary user, the service provider may notify the merchant that the transaction is canceled because no approval from the primary user is received and that the delay time has expired. Thus, the merchant and the secondary user may be notified of the cancelation of the transaction and the reasons for the cancelation.

By utilizing the above process, the primary user of a payment account may be notified of the transaction activities of the secondary user in real time. Thus, the primary user may better monitor and control the use of the payment account by the secondary user in real time. Further, the secondary user may receive approval from the primary user in real time without unnecessary delay to the transaction. in addition, the primary user may customize the types of transactions that require approval from the primary user in a restriction profile and the merchant may adjust the delay time based on the type of transactions. Thus, appropriate notification and delay may be implemented for a particular type of transaction.

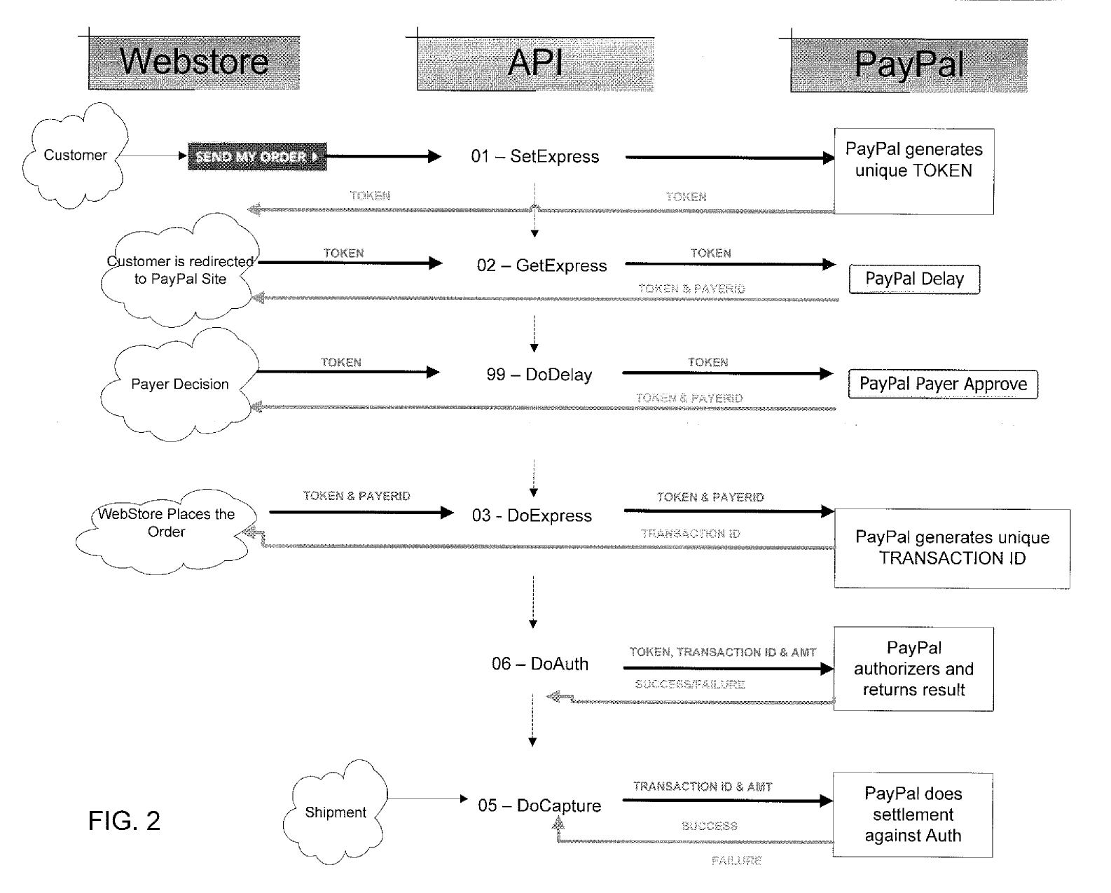

FIG. 2 is a sequence diagram illustrating the transaction approval process for an online purchase according to one embodiment. A customer may visit an online merchant's Web store. The customer may wish to purchase certain item from the online merchant's Web store. When the customer is ready to make a purchase, the customer may choose a payment provider service, such as PayPal, as a payment option at the Web store,

The Web store may send the customer's purchase order to the payment provider service via an Application Program Interface (“API”) SetExpress type function provided by PayPal, e.g., Step 104. The payment provider service may generate a token based on the purchase order received from the Web store. The payment provider service then may forward the generated token back to the Web store. An API GetExpress type function may redirect the customer to the payment provider service site along with the token. The payment provider service may request the customer to enter the ID and password for a payment account registered at the payment provider service. The customer may be a secondary user to a payment account at the payment provider service. The customer may enter the ID and password for a secondary user of a payment account. Because the customer is a secondary user of the payment account, the customer may select to use the payment provider service delay in order that the purchase may be approved by a primary user of the payment account. The ID and password for the secondary user of the payment account may be forwarded to the payment provider service along with the token for the purchase order.

The payment provider service may receive the secondary user's login credential and may determine whether approval from the primary user is required based on the restriction profile of the secondary user and the type of purchase requested, e.g., Step 106. If approval from the primary user is required, the payment provider service may execute an API DoDelay type function to delay the transaction for a specified period of time, e.g., Step 112. The payment provider service then may send an approval request to the primary user to request approval from the primary user, e.g., Step 110. As noted above, the payment provider service may text, email, or call the primary user. If the payment provider service receives an approval from the primary user within the specified period of time, PayPal may proceed with the transaction. An API DoExpress type function may generate an unique transaction ID and forward the same to the Web store. Upon receiving the transaction ID, the Web store may place the order for the purchase.

An API DoAuth type function may then authorize the transaction based on the token, the transaction ID, and the amount, e.g., Step 108. The payment provider service may return the result of authorization. If the authorization is successful and the customer has received the shipment of purchase, an API DoCapture type function may perform settlement. Thus, by using the above process, the primary user of a the payment provider service account may monitor and control a secondary user's payment transaction in real time.

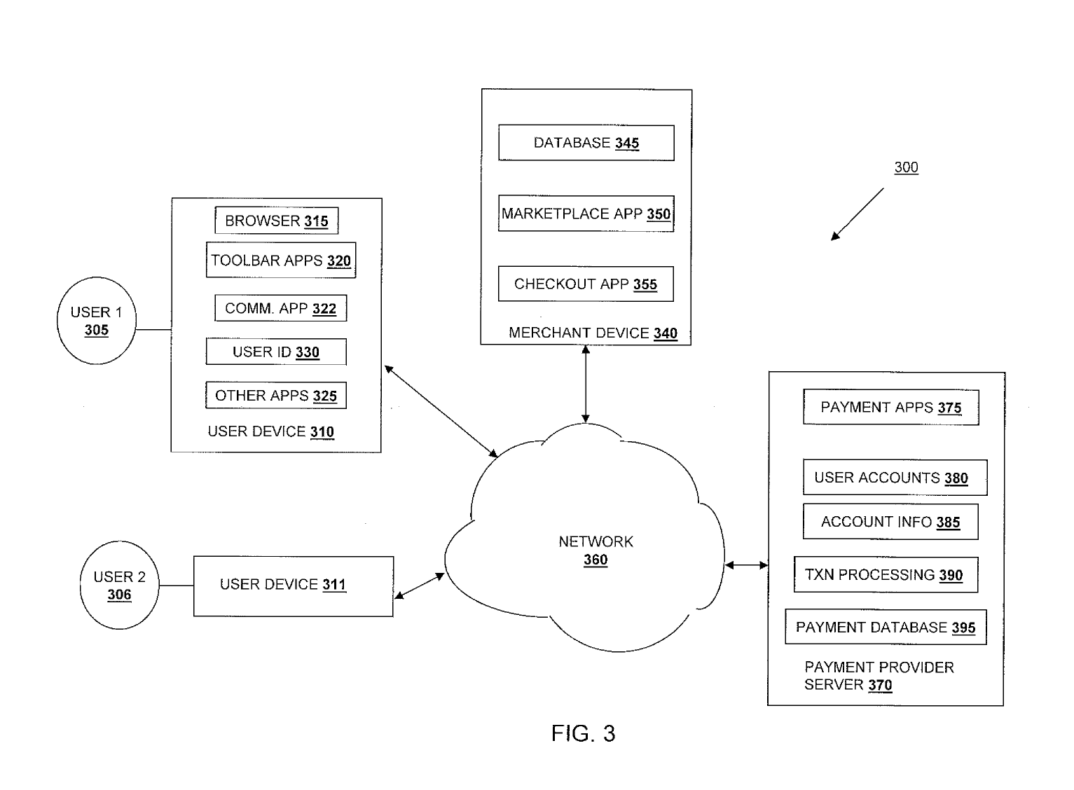

FIG. 3 is a block diagram of a networked system 300 configured to handle a transaction, such as described above, in accordance with an embodiment of the invention. Networked system 300 may comprise or implement a plurality of servers and/or software components that operate to perform various methodologies in accordance with the described embodiments. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 3 may be deployed in other ways and that the operations performed and/or the services provided by such servers may be combined or separated for a given implementation and may be performed by a greater number or fewer number of servers. One or more servers may be operated and/or maintained by the same or different entities.

System 300 may include user devices 310 and 311, a merchant server 340, and a payment provider server 370 in communication over a network 360. Payment provider server 370 may be maintained by a payment provider, such as PayPal, Inc. of San Jose, Calif. A user 305, such as a sender or consumer, utilizes user device 310 to perform a transaction using payment provider server 370. A user 306 may utilize user device 311 to receive transaction approval request and reply to the request. Note that transaction, as used herein, refers to any suitable action performed using the user device, including payments, transfer of information, display of information, etc. Although only one merchant server is shown, a plurality of merchant servers may be utilized if the user is purchasing gifts from multiple merchants.

User devices 310 and 311, merchant server 340, and payment provider server 370 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 300, and/or accessible over network 360.

Network 360 may be implemented as a single network or a combination of multiple networks. For example, in various embodiments, network 360 may include the Internet or one or more intranets, landline networks, wireless networks, and/or other appropriate types of networks.

User devices 310 and 311 may be implemented using any appropriate hardware and software configured for wired and/or wireless communication over network 360. For example, in one embodiment, the user device may be implemented as a personal computer (PC), a smart phone, personal digital assistant (PDA), laptop computer, and/or other types of computing devices capable of transmitting and/or receiving data, such as an iPad™ from Apple™.

User device 310 may include one or more browser applications 315 which may be used, for example, to provide a convenient interface to permit user 305 to browse information available over network 360. For example, in one embodiment, browser application 315 may be implemented as a web browser configured to view information available over the Internet, such as a user account for setting up a gift list and/or merchant sites for viewing and purchasing gifts. User device 310 may also include one or more toolbar applications 320 which may be used, for example, to provide client-side processing for performing desired tasks in response to operations selected by user 305. In one embodiment, toolbar application 320 may display a user interface in connection with browser application 315 as further described herein.

User device 310 may further include other applications 325 as may be desired in particular embodiments to provide desired features to user device 310. For example, other applications 325 may include security applications for implementing client-side security features, programmatic client applications for interfacing with appropriate application programming interfaces (APIs) over network 360, or other types of applications. Applications 325 may also include email, texting, voice and IM applications that allow user 305 to send and receive emails, calls, and texts through network 360, as well as applications that enable the user to communicate, transfer information, make payments, and otherwise utilize a smart wallet through the payment provider as discussed above. User device 310 includes one or more user identifiers 330 which may be implemented, for example, as operating system registry entries, cookies associated with browser application 315, identifiers associated with hardware of user device 310, or other appropriate identifiers, such as used for payment/user/device authentication. In one embodiment, user identifier 330 may be used by a payment service provider to associate user 305 with a particular account maintained by the payment provider as further described herein. A communications application 322, with associated interfaces, enables user device 310 to communicate within system 300. User device 311 may include similar components as user device 310.

Merchant server 340 may be maintained, for example, by a merchant or seller offering various products and/or services in exchange for payment to be received over network 360. Merchant server 340 may be used for POS or online purchases and transactions. Generally, merchant server 340 may be maintained by anyone or any entity that receives money, which includes charities as well as retailers and restaurants. For example, a recommended gift may be a donation to charity in the name of the recipient. Merchant server 340 includes a database 345 identifying available products and/or services (e.g., collectively referred to as items) which may be made available for viewing and purchase by user 305. Accordingly, merchant server 340 also includes a marketplace application 350 which may be configured to serve information over network 360 to browser 315 of user device 310. In one embodiment, user 305 may interact with marketplace application 350 through browser applications over network 360 in order to view various products, food items, or services identified in database 345.

Merchant server 340 also includes a checkout application 355 which may be configured to facilitate the purchase by user 305 of goods or services identified by marketplace application 350. Checkout application 355 may be configured to accept payment information from or on behalf of user 305 through payment service provider server 370 over network 360. For example, checkout application 355 may receive and process a payment confirmation from payment service provider server 370, as well as transmit transaction information to the payment provider and receive information from the payment provider (e.g., a transaction ID).

Payment provider server 370 may be maintained, for example, by an online payment service provider which may provide payment between user 305 and the operator of merchant server 340. In this regard, payment provider server 370 includes one or more payment applications 375 which may be configured to interact with user device 310 and/or merchant server 340 over network 360 to facilitate the purchase of goods or services, communicate/display information, and send payments by user 305 of user device 310 and as discussed above.

Payment provider server 370 also maintains a plurality of user accounts 380, each of which may include account information 385 associated with consumers, merchants, and funding sources, such as credit card companies. For example, account information 385 may include private financial information of users of devices such as account numbers, passwords, device identifiers, user names, phone numbers, credit card information, bank information, or other financial information which may be used to facilitate online transactions by user 305. Account information may also include user purchase history and user ratings. Profiles for primary and secondary users may also be included in account information. Offers and/or incentives from creditors may also be stored with account information 385, as well as bids submitted by a creditor for the payment provider offering a product of the creditor. Advantageously, payment application 375 may be configured to interact with merchant server 340 on behalf of user 305 during a transaction with checkout application 355 to track and manage purchases made by users and which and when funding sources are used.

A transaction processing application 390, which may be part of payment application 375 or separate, may be configured to receive information from a user device and/or merchant server 340 for processing and storage in a payment database 395. Transaction processing application 390 may include one or more applications to process information from user 305 for processing an order and payment using various selected funding instruments, including for initial purchase and payment after purchase as described herein. As such, transaction processing application 390 may store details of an order from individual users, including funding source used, credit options available, etc. Payment application 375 may be further configured to determine the existence of and to manage accounts for user 305, as well as create new accounts if necessary, such as the set up and management payments by the user after the initial purchase (e.g., pay after purchase) as discussed herein.

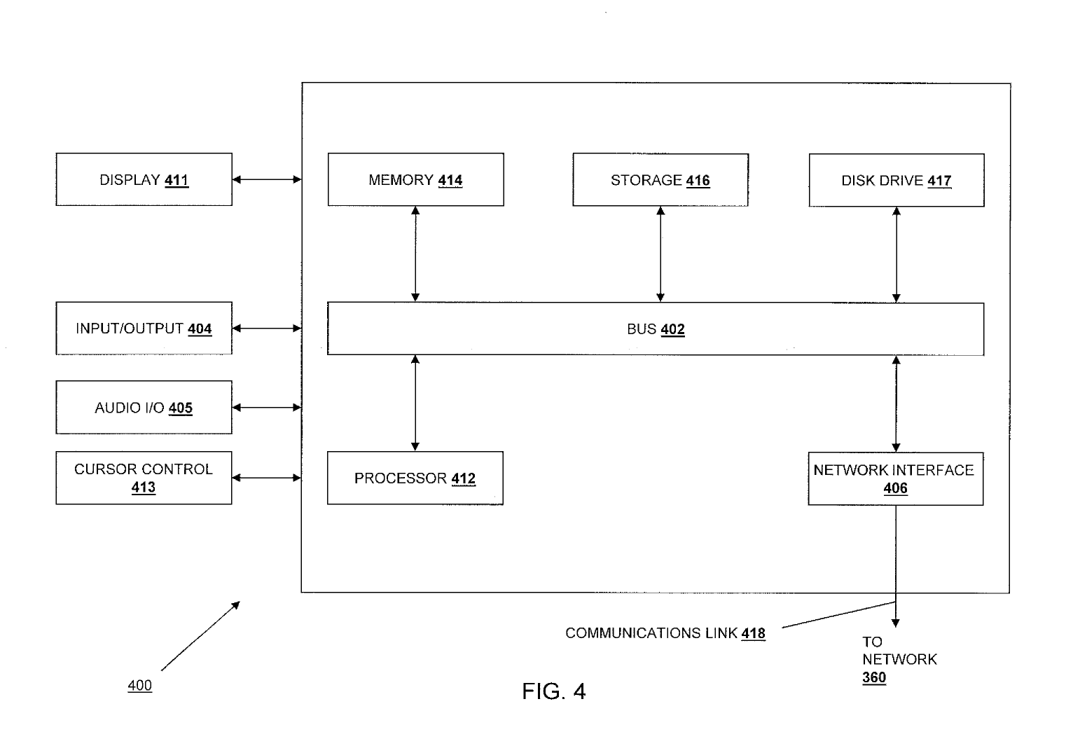

FIG. 4 is a block diagram of a computer system 400 suitable for implementing one or more embodiments of the present disclosure. In various implementations, the user device may comprise a personal computing device (e.g., smart phone, a computing tablet, a personal computer, laptop, PDA, Bluetooth device, key FOB, badge, etc.) capable of communicating with the network. The merchant and/or payment provider may utilize a network computing device (e.g., a network server) capable of communicating with the network. It should be appreciated that each of the devices utilized by users, merchants, and payment providers may be implemented as computer system 400 in a manner as follows.

Computer system 400 includes a bus 402 or other communication mechanism for communicating information data, signals, and information between various components of computer system 400. Components include an input/output (I/O) component 404 that processes a user action, such as selecting keys from a keypad/keyboard, selecting one or more buttons or links, etc., and sends a corresponding signal to bus 402. I/O component 404 may also include an output component, such as a display 411 and a cursor control 413 (such as a keyboard, keypad, mouse, etc.). An optional audio input/output component 405 may also be included to allow a user to use voice for inputting information by converting audio signals. Audio I/O component 405 may allow the user to hear audio. A transceiver or network interface 406 transmits and receives signals between computer system 400 and other devices, such as another user device, a merchant server, or a payment provider server via network 360. In one embodiment, the transmission is wireless, although other transmission mediums and methods may also be suitable. A processor 412, which can be a micro-controller, digital signal processor (DSP), or other processing component, processes these various signals, such as for display on computer system 400 or transmission to other devices via a communication link 418. Processor 412 may also control transmission of information, such as cookies or IP addresses, to other devices.

Components of computer system 400 also include a system memory component 414 (e.g., RAM), a static storage component 416 (e.g., ROM), and/or a disk drive 417. Computer system 400 performs specific operations by processor 412 and other components by executing one or more sequences of instructions contained in system memory component 414. Logic may be encoded in a computer readable medium, which may refer to any medium that participates in providing instructions to processor 412 for execution. Such a medium may take many forms, including but not limited to, non-volatile media, volatile media, and transmission media. In various implementations, non-volatile media includes optical or magnetic disks, volatile media includes dynamic memory, such as system memory component 414, and transmission media includes coaxial cables, copper wire, and fiber optics, including wires that comprise bus 402. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes,

RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 418 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for facilitating a financial transaction over a network, comprising:
a memory storing user account information comprising a payment account associated with a primary user and restriction information for a secondary user using the payment account; and
one or more processors in communication with the memory adapted to:
receive a payment request initiated by the secondary user for making a payment transaction using the payment account;
access the restriction information associated with the secondary user;
delay the payment transaction for a predetermined amount of time determined based on a type of payment transaction;
send an approval request to the primary user of the payment account; and
process the payment transaction when an approval from the primary user is received before the predetermined amount of time expires.

2. The system of claim 1, wherein the one or more processors is further adapted to cancel the payment transaction when an approval from the primary user is not received before the predetermined amount of time expires.

3. The system of claim 1, wherein the one or more processors is further adapted to automatically process the payment transaction when a disapproval from the primary user is not received before the predetermined amount of time expires.

4. The system of claim 1,
wherein the one or more processor is further adapted to send the approval request to the primary user based on the restriction information associated with the secondary user.

5. The system of claim 4, wherein the restriction information associated with the secondary user includes a condition under which the approval request is to be sent to the primary user.

6. The system of claim 1, wherein the approval request includes at least one of a time, a location, and the type of the payment transaction.

7. The system of claim 1, wherein the type of the payment transaction includes at least one of an amount of the payment transaction, a type of merchant, and a type of purchased item.

8. The system of claim 1, wherein the memory further stores communication preference of the primary user, and the one or more processor is further adapted to send the approval request via a communication medium based on the communication preference of the primary user.

9. The system of claim 1, wherein the one or more processors is further adapted to:
receive information indicating a location of the secondary user;
determine a merchant at which the secondary user is visiting based on the location;
send a notification to the primary user indicating the merchant at which the secondary user is visiting; and
receive pre-approval from the primary user for a purchase associated with the merchant before the secondary user makes a purchase at the merchant.

10. A method, comprising:
receiving, electronically by a hardware processor of a payment provider, a payment request initiated by a secondary user of a payment account for making a payment transaction using the payment account;
accessing restriction information of the secondary user using the payment account;
delaying the payment transaction for a predetermined amount of time determined based on a type of the payment transaction;
sending an approval request to a primary user of the payment account; and
processing the payment transaction when an approval from the primary user is received before the predetermined amount of time expires.

11. The method of claim 10, further comprising canceling the payment transaction when an approval from the primary user is not received before the predetermined amount of time expires.

12. The method of claim 10, further comprising automatically processing the payment transaction when a disapproval from the primary user is not received before the predetermined amount of time expires.

13. The method of claim 10, further comprising sending the approval request to the primary user based on the restriction information associated with the secondary user.

14. The method of claim 10, wherein the restriction information associated with the secondary user includes a condition under which the approval request is to be sent to the primary user.

15. The method of claim 10, wherein the approval request includes at least one of a time, a location, and a type of the payment transaction.

16. The method of claim 15, wherein the type of the payment transaction includes at least one of an amount of the payment transaction, a type of merchant, and a type of purchased item.

17. The method of claim 10, further comprising:
storing communication preference of the primary user; and
sending the approval request via a communication medium based on the communication preference of the primary user.

18. The method of claim 10, further comprising:
receiving information indicating a location of the secondary user;
determining a merchant at which the secondary user is visiting based on the location;
sending a notification to the primary user indicating the merchant at which the secondary user is visiting; and
receiving pre-approval from the primary user for a purchase associated with the merchant before the secondary user makes a purchase at the merchant.

19. A non-transitory machine-readable medium comprising a plurality of machine-readable instructions which when executed by one or more processors of a server are adapted to cause the server to perform a method comprising:
receiving a payment request initiated by a secondary user of a payment account for making a payment transaction using the payment account;
accessing restriction information associated with the secondary user delaying the payment transaction for a predetermined amount of time determined based on a type of the payment transaction;
sending an approval request to a primary user of the payment account;
processing the payment transaction when an approval from the primary user is received before the predetermined amount of time expires.

20. The non-transitory machine-readable medium of claim 19, wherein the method further comprises canceling the payment transaction when an approval from the primary user is not received before the predetermined amount of time expires.
